(19) United States
(12) Patent Application Publication
(10) Pub. No.: US 2022/0012066 A1
(43) Pub. Date: Jan. 13, 2022

(54) SYSTEM DEPLOYMENT DEVICE AND SYSTEM DEPLOYMENT METHOD

(71) Applicant: NEC Corporation, Minato-ku, Tokyo (JP)

(72) Inventor: Manabu NAKANOYA, Tokyo (JP)

(73) Assignee: NEC Corporation, Minato-ku, Tokyo (JP)

(21) Appl. No.: 17/296,794

(22) PCT Filed: Oct. 21, 2019
(86) PCT No.: PCT/JP2019/041304

§ 371 Date: May 25, 2021

(30) Foreign Application Priority Data
Dec. 6, 2018 (JP) 2018-228704

(51) Int. Cl. G06F 9/445; G06F 8/60

(52) U.S. Cl. CPC G06F 9/44505; G06F 8/60

(57) ABSTRACT

The system deployment device 10 includes a meta information acquisition unit 11 which acquires meta information relative to meaning with respect to setting of a variable part in a template describing the system configuration information, a comparison score calculation unit 13 which compares the variable part in the template with setting items in the design information, based on the acquired meta information and the design information, to score matching degree, a mapping unit 14 which calculates optimal matching between the variable part in the template and the setting items in the design information, based on the scored matching degree, and a variable embedding unit 15 which generates the definition for IT system deployment by assigning values corresponding to the setting items in the design information to the variable part in the template, based on the optimal matching.

### TECHNICAL FIELD

The present invention relates to a system deployment device and a system deployment method for automating deployment work in the development process of IT systems.

### BACKGROUND ART

The configuration work of an IT (Information Technology) system comprising a server, network devices, etc. includes, for example, the following three procedures of design work (realization of components, determination of relationships among components, and examination of detailed setting items within each component), realization of deployment work, and execution of deployment.

Each of these procedures used to be done manually by a human as an engineer. However, the use of tools that automate the second and third work related to deployment is spreading.

Non-patent literatures 1 and 2 describe configuration management tools that can automate deployment and other operations on a server and the other. When these tools are used, the user of the tool declaratively describes the desired state of the IT system. These tools change the target IT system to the state desired by the user, without making the user aware of the specific change work. By using these tools, an IT system administrator can automate the work related to deployment.

A notation based on an original grammar to describe the configuration of an IT system is defined in a tool that automates deployment. The user of the tool follows the notation to describe desired state of the IT system.

These tools also provide a reusable template of configuration description for each configuration setting target, such as middleware or specific network devices. The user of the tool updates only parameter values that the user desires to uniquely specify in the template. Therefore, the user of the tool can express the desired IT system status more easily.

When updating a template, the parameter variables to be updated need to be identified. The identification of the parameter variables is done manually by the user of the tool by referring to the variable names themselves, information of the reference points of the variables, and information in the template manual written in natural language. In general, there are several methods such as matching by the Levenshtein distance and matching by similarity calculation using Word2Vec which is a kind of machine learning method, as a method for matching relevant words for a word or a word string (sentence) such as variable names.

### CITATION LIST

### Non-Patent Literature

Non-patent Literature 1: “Puppet”, [online], [retrieved Oct. 29, 2018], Internet <URL: https://puppet.com/>
Non-Patent Literature 2: “Ansible”, [online], [retrieved Oct. 29, 2018], Internet <URL: https://www.ansible.com/>

### SUMMARY OF INVENTION

### Technical Problem

When a user (system developer or operator), who handles system deployment, performs deployment of an IT system using the above described configuration management tool and the template of configuration description for the tool, it is necessary to correctly reflect the configuration and setting (parameter) values intended by the user in the template of configuration description. Specifically, the user of the tool searches for the parameters that should be reflected in the template from the design documents such as a parameter sheet structured in a unique format for each development environment that is handled by the user. Then, the user updates the corresponding appropriate parameter descriptions in the template.

In general, a grammar for describing parameter variables that contain setting values and so on is defined in the template of configuration management tools. However, there are only rough rules for identifying each parameter. For example, as in general programming languages, a rule only exists that each parameter must be a unique string. Therefore, while the developer of the template can freely name the parameter variables, the user of the template needs to read the meaning of the parameters from the name and description of the parameter variables, or from the template manual written in natural language.

In addition, a design document such as a parameter sheet that users have are written according to data description structures and naming conventions based on rules that are unique to the system and its users. Basically, the user is required to understand those rules and structures in order to read the meaning of each setting value.

The above matching between parameter variables and design items based on language understanding cannot be achieved by a simple process such as matching based on Levenshtein distance or matching by Word2Vec. Therefore, it is necessary to manually examine each parameter variable one by one by a human who has knowledge of the setting object. Such intervention of manual work is an obstacle to application of a configuration management tool to a large-scale system. It also an obstacle to application of a configuration management tool to an IT system operation style (for example, a development method called DevOps) that shortens a deployment cycle and increases a number of deployments.

Therefore, the main object of the present invention is to provide a system deployment device and a system deployment method that can easily reflect design parameters in deployment of an IT system in a deployment tool without manual intervention.

### Solution to Problem

A system deployment device according to the present invention generates a definition for specific system deployment, based on design information in which specific values of system configuration information used for IT system deployment are described, wherein the system deployment device includes meta information acquisition means for acquiring meta information relative to meaning with respect to setting of a variable part in a template describing the system configuration information, comparison score calculation means for comparing the variable part in the template with setting items in the design information, based on the acquired meta information and the design information, to score matching degree, mapping means for calculating optimal matching between the variable part in the template and the setting items in the design information, based on the scored matching degree, and variable embedding means for generating the definition for IT system deployment by assigning values corresponding to the setting items in the design information to the variable part in the template, based on the optimal matching.

The system deployment method according to the present invention generates a definition for specific system deployment, based on design information in which specific values of system configuration information used for IT system deployment are described, wherein the system deployment method acquires meta information relative to meaning with respect to setting of a variable part in a template describing the system configuration information, compares the variable part in the template with setting items in the design information, based on the acquired meta information and the design information, to score matching degree, calculates optimal matching between the variable part in the template and the setting items in the design information, based on the scored matching degree, and generates the definition for IT system deployment by assigning values corresponding to the setting items in the design information to the variable part in the template, based on the optimal matching.

A system deployment program according to the present invention, for implementing a system deployment method generating a definition for specific system deployment, based on design information in which specific values of system configuration information used for IT system deployment are described, causes a computer to perform acquiring meta information relative to meaning with respect to setting of a variable part in a template describing the system configuration information, comparing the variable part in the template with setting items in the design information, based on the acquired meta information and the design information, to score matching degree, calculating optimal matching between the variable part in the template and the setting items in the design information, based on the scored matching degree, and generating the definition for IT system deployment by assigning values corresponding to the setting items in the design information to the variable part in the template, based on the optimal matching. The program stored in a computer readable recording medium, when executed by a processor, performs the above processes.

### Advantageous Effects of Invention

The invention makes it possible to easily reflect the design parameters in the deployment of IT systems in the deployment tool without manual intervention.

### BRIEF DESCRIPTION OF DRAWINGS

FIG. 1 It depicts a block diagram showing a configuration example of the first example embodiment of a system deployment device.

FIG. 2 It depicts a flowchart showing an operation of a system deployment device of the first example embodiment.

FIG. 3 It depicts an explanatory diagram showing an example of a template of deployment tool.

FIG. 4 It depicts an explanatory diagram showing an example of an extraction rule.

FIG. 5 It depicts an explanatory diagram showing an extraction result when an extraction rule is applied to a template.

FIG. 6 It depicts an explanatory diagram showing an input example of design information.

FIG. 7 It depicts an explanatory diagram showing an example of a comparison rule.

FIG. 8 It depicts an explanatory diagram showing an example of a calculation result of comparison scores for variable names.

FIG. 9 It depicts an explanatory diagram showing an example of a calculation result of comparison scores of an attribute.

FIG. 10 It depicts an explanatory diagram showing an example of a calculation result of the category.

FIG. 11 It depicts an explanatory diagram showing an example of an overall score.

FIG. 12 It depicts an explanatory diagram showing an example of a variable definition section in which the setting values desired by the user are embedded.

FIG. 13 It depicts a block diagram showing a configuration example of the second example embodiment of a system deployment device.

FIG. 14 It depicts a flowchart showing an operation of a system deployment device of the second example embodiment.

FIG. 15 It depicts a block diagram showing an example of a computer system.

FIG. 16 It depicts a block diagram of the main part of a system deployment device.

FIG. 17 It depicts a block diagram showing a configuration example of meta information acquisition means.

FIG. 18 It depicts a block diagram showing another configuration example of meta information acquisition means.

### DESCRIPTION OF EMBODIMENTS

Hereinafter, example embodiments of the present invention will be described with reference to the drawings.

### Example Embodiment 1

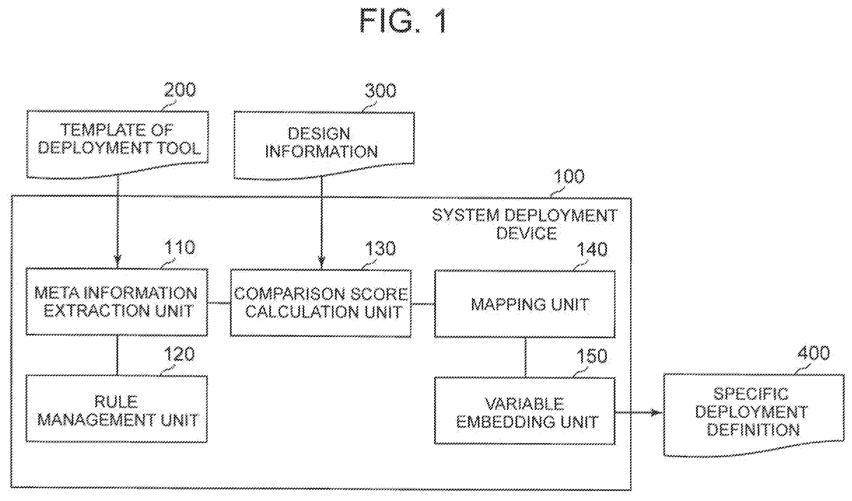

FIG. 1 is a block diagram showing a configuration example of the first example embodiment of a system deployment device. The system deployment device 100 shown in FIG. 1 includes a meta information extraction unit 110, a rule management unit 120, a comparison score calculation unit 130, a mapping unit 140, and a variable embedding unit 150. A template 200 of the deployment tool and design information 300 (an example of system configuration information used for IT system deployment) are input to the system deployment device 100. The system deployment device 100 outputs the specific deployment definition 400. The template 200 of the deployment tool corresponds to a template in which the system configuration information used for the IT system deployment (deployment in the IT system) is described.

The rule management unit 120 can be realized, for example, by a storage unit that stores extraction rules. The meta information extraction unit 110 extracts meta information relative to the meaning with respect to the settings by referring to the extraction rules recorded in the rule management unit 120 in advance. The comparison score calculation unit 130 compares the meta information with the design information 300 based on the comparison rules, and calculates the score of the matching degree. In other words, the comparison score calculation unit 130 scores (quantifies) the matching degree.

The mapping unit 140 calculates the optimal matching (optimal correspondence) between the parameter variables and the design items such that the score is maximized by solving an allocation problem.

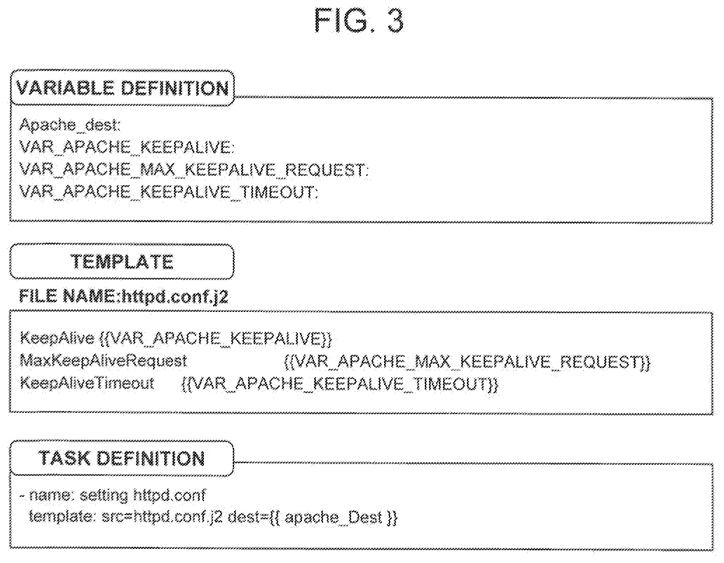

The variable embedding unit 150 embeds the setting values of the corresponding design information 300 in the variable definition section of the template 200 of the deployment tool according to the optimal matching. The configuration of the template 200 will be described below with reference to FIG. 3.

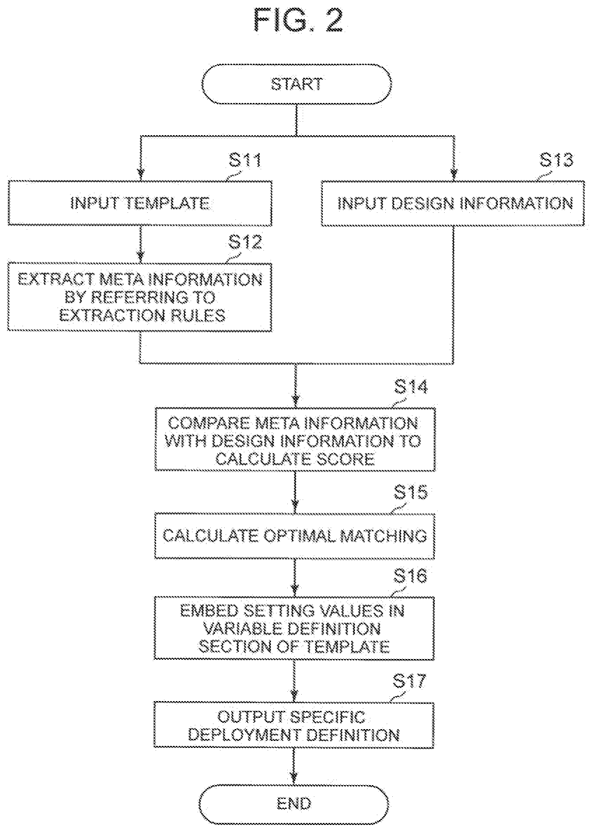

Next, the operation of the system deployment device 100 will be described with reference to the flowchart in FIG. 2 and the explanatory diagrams in FIGS. 3 to 12.

The user of the tool inputs the template 200 of the deployment tool corresponding to the function to be deployed to the system deployment device 100 (step S11). When the template 200 of the deployment tool is input, the meta information extraction unit 110 receives the input. The meta information extraction unit 110 extracts meta information from the template 200 by referring to the extraction rules recorded in the rule management unit 120 in advance (step S12).

FIG. 3 illustrates a template of a deployment tool that deploys Apache that is middleware for HTTP (Hypertext Transfer Protocol) servers. The template illustrated in FIG. 3 is roughly composed of three blocks of a variable definition section, a template section, and a task definition section.

In the variable definition section, the parameter variable definitions that contain the values of the parameters to be set are listed. In the template section, a template for a configuration file of Apache are defined. In the template section, some of the parameter variables defined in the variable definition section are referred to. In the task definition section, operations required to reflect the configuration are defined. In the task definition section, as in the template section, some of the parameter variables are referred to as necessary.

The variable definition section corresponds to the variable part in the template. In addition, meta information (information about the meaning regarding the setting) can be expressed as information that suggests the meaning of the variable part in the configuration.

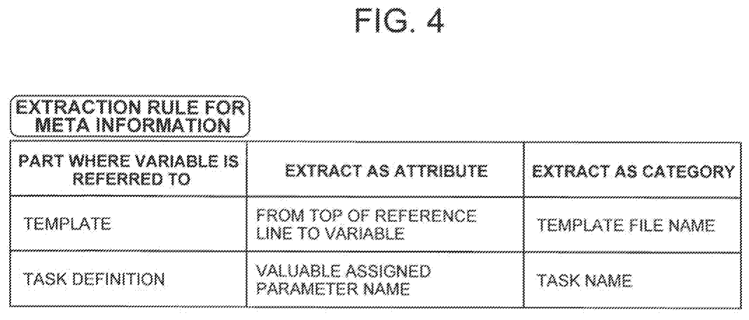

FIG. 4 illustrates extraction rules for meta information recorded in the rule management unit 120. As meta information, there are two types of information. One is an attribute (hereinafter referred to as “Attribute”) that correspond to a character string directly representing a setting item and another is a category (hereinafter referred to as “Category”) that represents related information of the setting item. The extraction rule specifies an extraction method according to a part where the parameter variable is referred to for each of the two types. Therefore, when the parameter variables (which can be referred to in the template section and task definition section in a template, as described above) defined in the variable definition section (an example of a variable part in a template) are regarded as a use form in a template of the variable definition section, the extraction rules include, at least, a rule that indicates what type (for example, Attribute and Category) of information the meta information is extracted as, depending on the type of use. In other words, the extraction rules include a rule that can specify what type of information the meta information is to be extracted as, depending on the use form, in the template, of the variable part in the template.

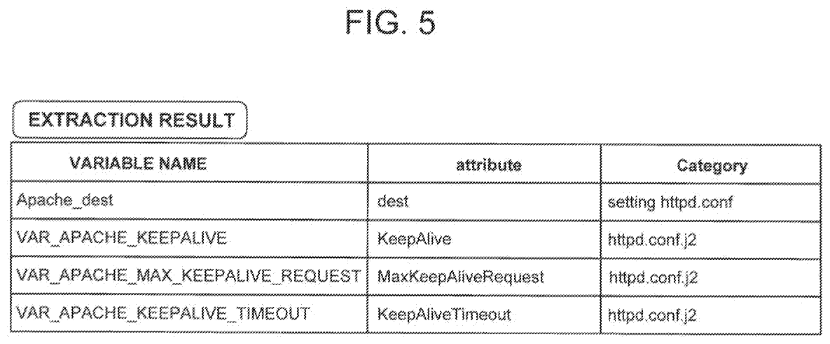

FIG. 5 shows extraction results when the extraction rules illustrated in FIG. 4 are applied to the template illustrated in FIG. 3.

After the meta information has been extracted, the user inputs the design information 300 describing the setting values of an object to be deployed into the system deployment device 100 (step S13). The input of the design information 300 may be performed at the same time as the input of the template 200 of the deployment tool. The comparison score calculation unit 130 receives the input design information 300.

The comparison score calculation unit 130 compares the meta information extracted by the meta information extracting unit 110 with the design information 300 according to the comparison rules defined in advance, and calculates a comparison score representing the result of the comparison (step S14). The method of calculating the comparison score in step S14 is described in detail below.

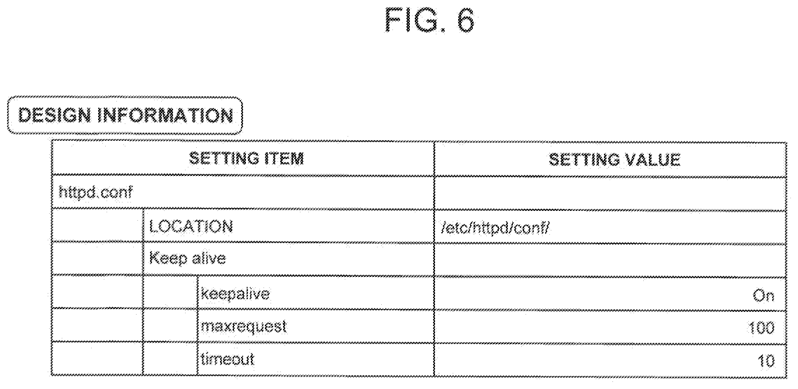

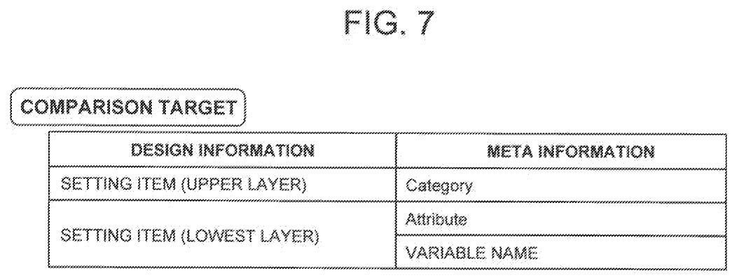

FIG. 6 shows an example of inputting design information 300. In the example shown in FIG. 6, in the design information 300, setting items having a hierarchical structure (also called structural positioning) are listed with their setting values. In the example shown in FIG. 6, the setting items with a hierarchical structure (also referred to as structural positioning) are listed in the design information 300 along with their setting values. FIG. 7 is an explanatory diagram showing an example of a comparison rule. In the example shown in FIG. 7, the comparison rule specifies which item in the design information should be compared with each of the meta information types Attribute and Category.

The setting item (lowest layer) in the comparison rule illustrated in FIG. 7 represents setting item for which there is no lower layer. In the example shown in FIG. 5, “keepalive”, “maxrequest”, and “timeout” are the setting items (lowest layer). A setting item (higher layer) represents a setting item that exists in a higher layer that does not belong to the setting item (lowest layer).

In the process of step S14, the comparison score calculation unit 130 first identifies the comparison target according to the structural positioning of the setting items. For example, according to the comparison rules shown in FIG. 7, the setting item (higher layer) is associated with Category of the meta information, and the setting item (lowest layer) is associated with Attribute of the meta information. The comparison score calculation unit 130 classifies the meta information into three types of variable name, Attribute, and Category.

The comparison score calculation unit 130 then calculates the similarity of each string for these three categories of the meta information.

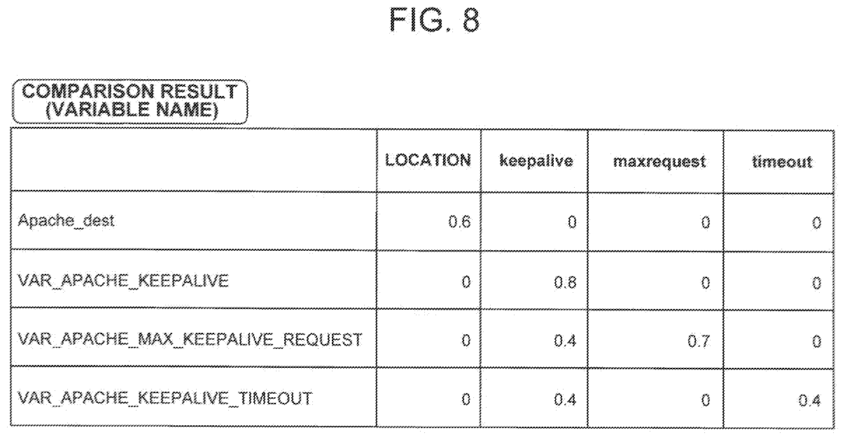

In other words, the comparison score calculating unit 130 calculates the similarity between the string of the variable name in the meta information and the string of the variable name in the design information 300. In the same way, the comparison score calculating unit 130 calculates the similarity between the string of Attribute in the the meta information and the string of Attribute in the design information 300. In the same way, the comparison score calculation unit 130 calculates the similarity between the string of Category in the meta information and the string of Category in the design information 300. The similarity is a numerical value (comparison score) that represents the degree of relevance between strings, calculated by any string similarity calculation technology such as Word2Vec. An example of the procedure for calculating these three types of comparison scores will be explained referring to FIGS. 8 to 10.

FIG. 8 is an explanatory diagram showing an example of a calculation result of comparison scores for variable names. In the comparison of variable names, the comparison score calculation unit 130 compares the parameter variables defined in the variable definition section of the template (refer to FIG. 3) with the setting items (lowest layer) (refer to FIG. 6) described in the design information 300, and calculates the result of the comparison (comparison score) (refer to FIG. 8). The comparison score calculation unit 130 uses any comparison algorithm that can calculate the comparison score by considering not only simple word matching but also distinction between capital letter and small letter, and a synonym, for the comparison.

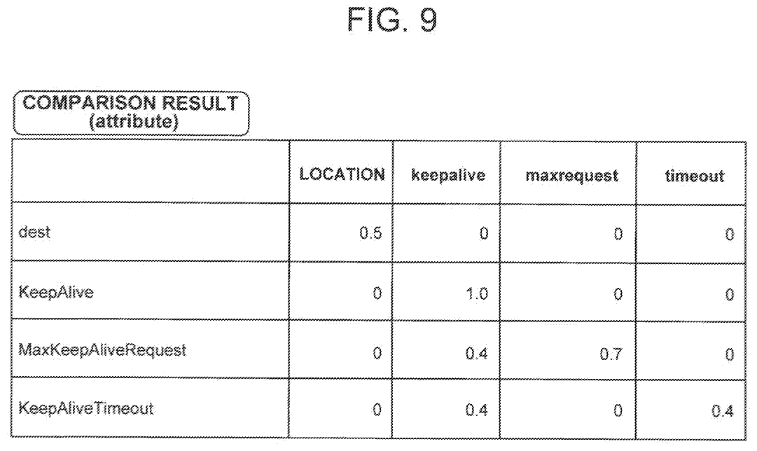

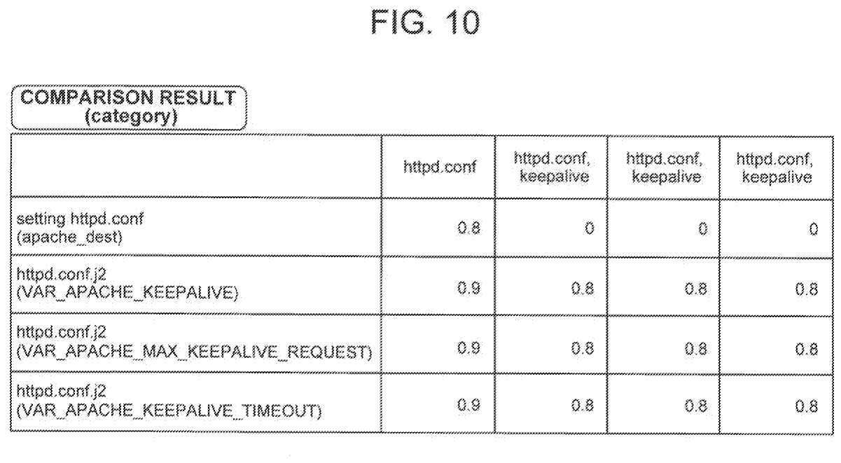

FIG. 9 shows an explanatory diagram showing an example of a calculation result of comparison scores of Attribute. FIG. 10 is an explanatory diagram showing an example of a calculation result of Category. The comparison score calculation unit 130 compares the parameter variables with the setting items (lowest layer) (see FIG. 6) for Attribute and Category as well, and calculates the result of the comparison (comparison score).

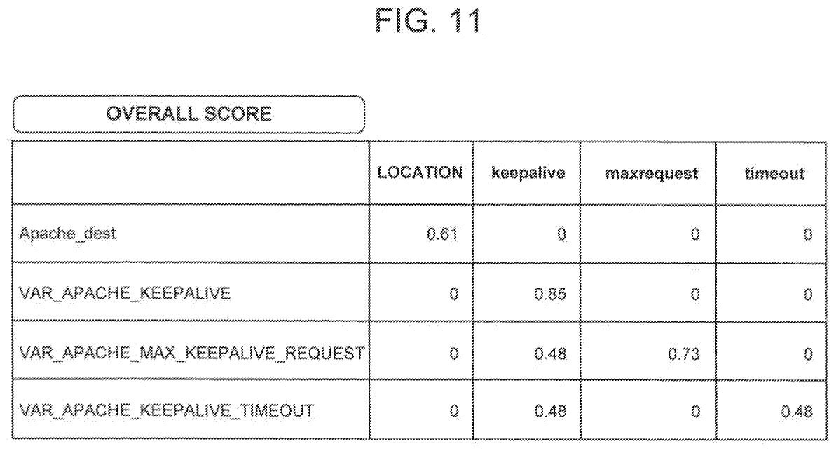

When the three types of comparison scores have been calculated, the comparison score calculation unit 130 averages the respective comparison scores in an arbitrary manner to calculate an overall score. FIG. 11 illustrates the overall score that is the harmonic mean of the result of the calculation of the comparison score for the variable name (refer to FIG. 8), the result of the calculation of the comparison score for Attribute (refer to FIG. 9), and the result of the calculation of Category (refer to FIG. 10).

The calculated overall score is sent to the mapping unit 140. The mapping unit 140 calculates the optimal matching by solving the matching between the parameter variables and the design items as an allocation problem to maximize the overall score as shown in FIG. 11 (step S15).

In the example shown in FIG. 11, since the matching that corresponds the diagonal components of the table (Apache_dest and location, VAR_APACHE_KEEPALIVE and keepalive, VAR_APACHE_MAX_KEEPALIVE_REQUEST and maxrequest, VAR_APACHE_KEEPALIVE_TIMEOUT and timeout) has the highest overall score, the mapping unit 140 adopts that matching as the best matching.

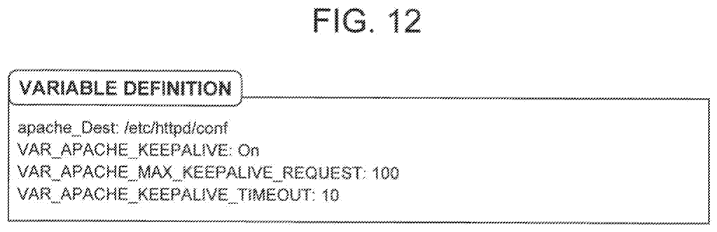

The optimal matching result is sent to the variable embedding unit 150. The variable embedding unit 150 embeds the setting values of the corresponding design information 300 in the variable definition section of the template 200 of the deployment tool according to the optimal matching (step S16). FIG. 12 is an explanatory diagram showing an example of the variable definition section in which the setting values desired by the user are embedded. The variable embedding unit 150 outputs the template of the deployment tool in which the setting values as illustrated in FIG. 12 are embedded as a deployment definition (specific deployment definition 400) that can be used for specific IT system deployment for the user (step S17).

As described above, in this example embodiment, a specific deployment definition 400 is generated in which the setting values described in the design information 300 are appropriately embedded in the template 200 of the deployment tool. Therefore, a specific deployment definition, to which the individually and specifically designed setting values are reflected, is automatically generated from the template of the deployment tool that has been prepared in a generic manner.

### Example Embodiment 2

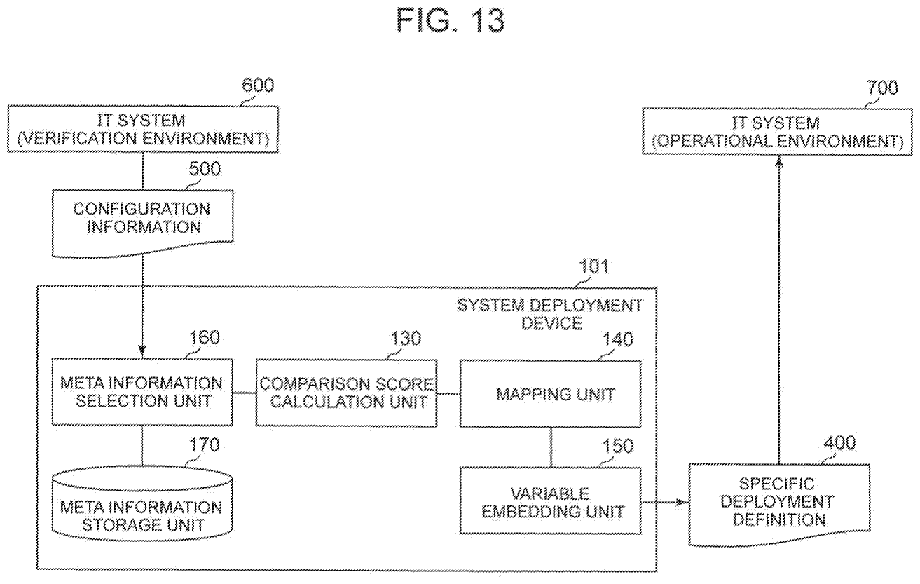

FIG. 13 shows a block diagram showing a configuration example of the second example embodiment of a system deployment device. The system deployment device 101 shown in FIG. 13 includes a comparison score calculation unit 130, a mapping unit 140, and a variable embedding unit 150, similar to the system deployment device 100 of the first example embodiment. However, instead of the meta information extraction unit 110 and the rule management unit 120, it has a meta information selection unit 160 and a meta information storage unit 170.

In the first example embodiment, the template 200 of deployment tool and the design information 300 are input to the system deployment device 100, however the configuration information 500 extracted from the IT system (verification environment) 600 is input to the system deployment device 101 of this example embodiment.

In general, a parameter sheet, which is an example of design information, is generated from the configuration information. For example, the parameter sheet describes the specific values of the configuration information.

The meta information storage unit 170 stores meta information extracted from a plurality of templates of the deployment tool in advance, i.e., the respective meta information extracted from a group of templates. The meta information storage unit 170 stores meta information extracted from the template as shown in FIG. 5, for example. In other words, the meta information storage unit 170 stores meta information extracted by an extraction unit having a function similar to that of the meta information extraction unit 110 (refer to FIG. 1) which is not included in the system deployment device 101. Although the extraction unit having the same function as that of the meta information extraction unit 110 is external to the system deployment device 101, the extraction unit may be included in the system deployment device 101.

When the configuration information 500 is input, the meta information selection unit 160 selects meta information that matches the component to be deployed described in the configuration information from the meta information storage unit 170. The meta information selection unit 160 sends the meta information and the configuration information 500 to the comparison score calculation unit 130.

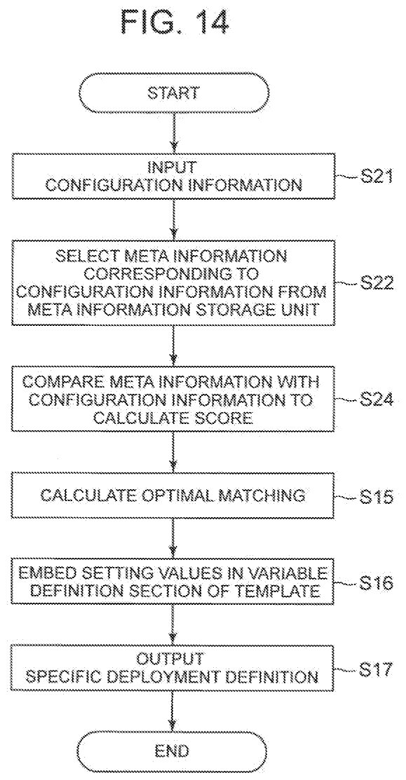

Next, the operation of the system deployment device 101 will be explained with reference to the flowchart in FIG. 14.

First, the configuration information 500 is input to the system deployment device 101 (step S21). The configuration information 500 is information extracted from the IT system (IT system (verification environment) 600). The meta information selection unit 160 selects meta information corresponding to the input configuration information 500 from a plurality of meta information stored in the meta information storage unit 170 (step S22). In the process of step S22, the meta information selection unit 160 selects the meta information corresponding to the component to be deployed that is handled by the configuration information 500.

The comparison score calculation unit 130, the mapping unit 140, and the variable embedding unit 150 perform the same processing as in the first example embodiment. However, the comparison score calculating unit 130 determines the design information 300 from the configuration information 500, compares the meta information with the design information 300, and calculates a score of matching degree.

In this example embodiment, the specific deployment definition 400 output from the variable embedding unit 150 is executed by a configuration management tool in the IT system (operational environment) 700, and the setting based on the specific deployment definition 400 is reflected in the IT system (operational environment) 700. In this way, the parameters set in the IT system (verification environment) 600 are automatically reflected in the IT system (operational environment) 700.

In this example embodiment, settings between several different environments can be automatically synchronized.

In the first example embodiment, the comparison score calculation unit 130 compared the meta information extracted from the input template with the input design information 300, and in the second example embodiment, the comparison score calculation unit 130 compared the meta information selected from a plurality of meta information stored in advance with the input configuration information 500. However, the comparison score calculation unit 130 may be configured to compare the meta information selected from a plurality of meta information stored in advance with the input design information 300. In such a configuration, the meta information selection unit 160 and the meta information storage unit 170 are provided instead of the meta information extraction unit 110 and the rule management unit 120 in the first example embodiment shown in FIG. 1. Further, the template 200 of the deployment tool is not input to the system deployment device 100.

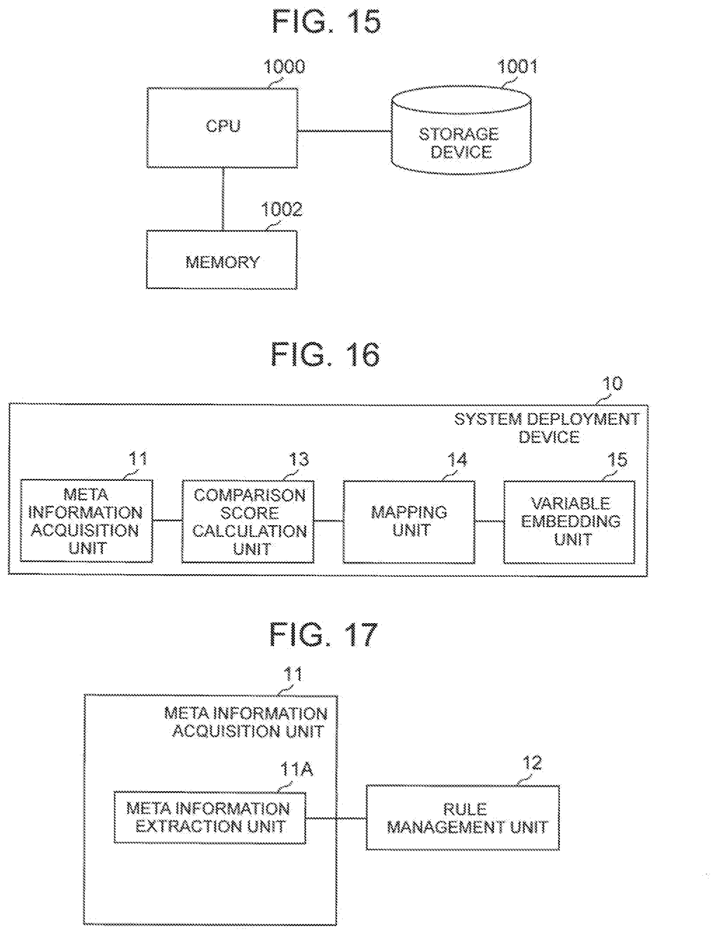

FIG. 15 is a block diagram showing an example of a computer with a CPU (Central Processing Unit). The computer is implemented in the system deployment devices 100, 101. The CPU 1000 executes processing in accordance with a program stored in a storage device 1001 to realize the functions in the above example embodiments. That is, the computer realizes the functions of the meta information extraction unit 110, the rule management unit 120, the comparison score calculation unit 130, the mapping unit 140, and the variable embedding unit 150 in the system deployment device 100 shown in FIG. 1. In addition, the rule management unit 120 may be realized by the storage device 1001 or the memory 1002. The CPU 1000 also realizes the functions of the meta information selection unit 160, the comparison score calculation unit 130, the mapping unit 140, and the variable embedding unit 150 shown in FIG. 13.

The storage device 1001 is, for example, a non-transitory computer readable medium. The non-transitory computer readable medium includes various types of tangible storage media. Specific examples of the non-transitory computer readable medium include magnetic storage media (for example, flexible disk, magnetic tape, hard disk drive), magneto-optical storage media (for example, magneto-optical disc), compact disc-read only memory (CD-ROM), compact disc-recordable (CD-R), compact disc-rewritable (CD-R/W), and semiconductor memories (for example, mask ROM, programmable ROM (PROM), erasable PROM (EPROM), flash ROM).

The program may be stored in various types of transitory computer readable media. The transitory computer readable medium is supplied with the program through, for example, a wired or wireless communication channel, or, via electric signals, optical signals, or electromagnetic waves.

The memory 1002 is a storage means implemented by a RAM (random access memory), for example, and temporarily stores data when the CPU 1000 executes processing. A conceivable mode is that the program held in the storage device 1001 or in a transitory computer readable medium is transferred to the memory 1002, and the CPU 1000 executes processing on the basis of the program in the memory 1002. The meta information storage unit 170 shown in FIG. 13 is realized by the memory 1002 or the storage device 1001.

FIG. 16 is a block diagram of the main part of the system deployment device. The system deployment device 10 shown in FIG. 16 comprises a meta information acquisition unit 11 (in the example embodiments, realized by the meta information extraction unit 110 or the meta information selection unit 160) which acquires meta information relative to meaning with respect to setting of a variable part in a template describing the system configuration information, a comparison score calculation unit 13 (in the example embodiments, realized by the comparison score calculation unit 130) which compares the variable part in the template with setting items in the design information, based on the acquired meta information and the design information, to score matching degree, a mapping unit 14 (in the example embodiments, realized by the mapping unit 140) which calculates optimal matching between the variable part in the template and the setting items in the design information, based on the scored matching degree, and a variable embedding unit 15 (in the example embodiments, realized by the variable embedding unit 150) which generates the definition for IT system deployment by assigning values corresponding to the setting items in the design information to the variable part in the template, based on the optimal matching.

FIG. 17 shows a block diagram showing a configuration example of the meta information acquisition unit 11. The meta information acquisition unit 11 shown in FIG. 17 includes a meta information extraction unit 11A (in the example embodiments, realized by the meta information extraction unit 110) which extracts the meta information from the input template, referring to the extraction rules. In addition, the rule management unit 12 (in the example embodiments, realized by the rule management unit 120) manages the extraction rules for extracting meta information.

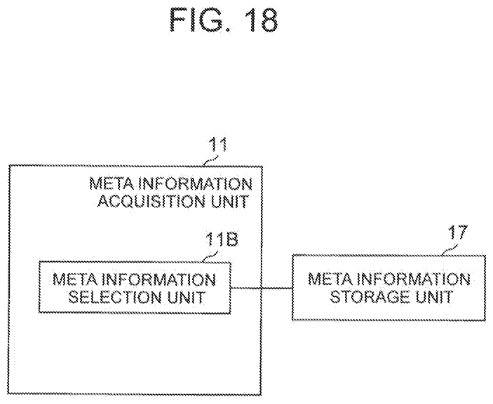

FIG. 18 shows a block diagram showing another configuration example of the meta information acquisition unit 11. The meta information acquisition unit 11 shown in FIG. 18 includes a meta information selection unit 11B (in the example embodiments, realized by the meta information selection unit 160) which selects the meta information from the plurality of meta information stored in a meta information storage unit 17 (in the example embodiments, realized by the meta information storage unit 170), using information relative to an object to be deployed described in the configuration information. In addition, the meta information storage unit 17 stories a plurality of meta information extracted from a group of templates describing the system configuration information used in the IT system deployment.

A part of or all of the above example embodiments may also be described as, but not limited to, the following supplementary notes.

(Supplementary note 1) A system deployment device generating a definition for specific system deployment, based on design information in which specific values of system configuration information used for IT system deployment are described, comprising:

meta information acquisition means for acquiring meta information relative to meaning with respect to setting of a variable part in a template describing the system configuration information,

comparison score calculation means for comparing the variable part in the template with setting items in the design information, based on the acquired meta information and the design information, to score matching degree,

mapping means for calculating optimal matching between the variable part in the template and the setting items in the design information, based on the scored matching degree, and

variable embedding means for generating the definition for IT system deployment by assigning values corresponding to the setting items in the design information to the variable part in the template, based on the optimal matching.

(Supplementary note 2) The system deployment device according to Supplementary note 1, further comprising rule management means for managing extraction rules for extracting the meta information,

wherein the meta information acquisition means includes meta information extraction means for extracting the meta information from the input template, referring to the extraction rules.

(Supplementary note 3) The system deployment device according to Supplementary note 2, wherein

the meta information extraction means decides what type of information to extract the meta information as, depending on the use form, in the template, of the variable part in the template.

(Supplementary note 4) The system deployment device according to Supplementary note 3, wherein

the rule management means has rules that can specify what type of information the meta information is extracted as, depending on the use form, in the template, of the variable part in the template.

(Supplementary note 5) The system deployment device according to Supplementary note 1, further comprising meta information storage means for storing a plurality of meta information extracted from a group of templates describing the system configuration information used in the IT system deployment,

wherein the meta information acquisition means includes meta information selection means for selecting the meta information from the plurality of meta information stored in the meta information storage means, using information relative to an object to be deployed described in the configuration information.

(Supplementary note 6) The system deployment device according to any one of Supplementary notes 1 to 5, wherein

the comparison score calculating means identifies comparison targets according to a type of the meta information acquired by the meta information acquiring means and structural positioning of the setting items in the design information, scores the matching degree between the comparison targets for the each comparison target, and calculates overall matching degree by averaging the scored matching degrees, and

the mapping means calculates the optimal matching using the overall matching degree.

(Supplementary note 7) A system deployment method generating a definition for specific system deployment, based on design information in which specific values of system configuration information used for IT system deployment are described, comprising:

acquiring meta information relative to meaning with respect to setting of a variable part in a template describing the system configuration information,

comparing the variable part in the template with setting items in the design information, based on the acquired meta information and the design information, to score matching degree,

calculating optimal matching between the variable part in the template and the setting items in the design information, based on the scored matching degree, and

generating the definition for IT system deployment by assigning values corresponding to the setting items in the design information to the variable part in the template, based on the optimal matching.

(Supplementary note 8) The system deployment method according to Supplementary note 7, further comprising:

managing extraction rules for extracting the meta information, and

extracting the meta information from the input template in order to acquire the meta information, referring to the extraction rules.

(Supplementary note 9) The system deployment method according to Supplementary note 8, further comprising:

when extracting the meta information, deciding what type of information to extract the meta information as, depending on the use form, in the template, of the variable part in the template.

(Supplementary note 10) The system deployment method according to Supplementary note 9, further comprising:

managing rules that can specify what type of information the meta information is extracted as, depending on the use form, in the template, of the variable part in the template.

(Supplementary note 11) The system deployment method according to Supplementary note 7, further comprising:

selecting the meta information from a plurality of meta information stored in meta information storage means which stores the plurality of meta information extracted from a group of templates describing the system configuration information used in the IT system deployment, using information relative to an object to be deployed described in the configuration information.

(Supplementary note 12) The system deployment method according to any one of Supplementary notes 7 to 11, further comprising:

identifying comparison targets according to a type of the meta information and structural positioning of the setting items in the design information,

scoring the matching degree between the comparison targets for the each comparison target,

calculating overall matching degree by averaging the scored matching degrees, and

calculating the optimal matching using the overall matching degree.

(Supplementary note 13) A system deployment program, for implementing a system deployment method generating a definition for specific system deployment, based on design information in which specific values of system configuration information used for IT system deployment are described, causes a computer to perform acquiring meta information relative to meaning with respect to setting of a variable part in a template describing the system configuration information, comparing the variable part in the template with setting items in the design information, based on the acquired meta information and the design information, to score matching degree, calculating optimal matching between the variable part in the template and the setting items in the design information, based on the scored matching degree, and generating the definition for IT system deployment by assigning values corresponding to the setting items in the design information to the variable part in the template, based on the optimal matching.

(Supplementary note 14) The system deployment program according to Supplementary note 13, causing the computer to perform

managing extraction rules for extracting the meta information, and

extracting the meta information from the input template in order to acquire the meta information, referring to the extraction rules.

(Supplementary note 15) The system deployment program according to Supplementary note 14, causing the computer to perform

when extracting the meta information, deciding what type of information to extract the meta information as, depending on the use form, in the template, of the variable part in the template.

(Supplementary note 16) The system deployment program according to Supplementary note 15, causing the computer to perform

managing rules that can specify what type of information the meta information is extracted as, depending on the use form, in the template, of the variable part in the template.

(Supplementary note 17) The system deployment program according to Supplementary note 13, causing the computer to perform

selecting the meta information from a plurality of meta information stored in meta information storage means which stores the plurality of meta information extracted from a group of templates describing the system configuration information used in the IT system deployment, using information relative to an object to be deployed described in the configuration information.

(Supplementary note 18) The system deployment program according to any one of Supplementary notes 13 to 17, causing the computer to perform

identifying comparison targets according to a type of the meta information and structural positioning of the setting items in the design information,

scoring the matching degree between the comparison targets for the each comparison target,

calculating overall matching degree by averaging the scored matching degrees, and

calculating the optimal matching using the overall matching degree.

In addition, the program stored in a computer readable recording medium corresponding to any one of Supplementary notes 13 to 17, when executed by a processor, performs the processes in any one of Supplementary notes 13 to 17.

While the present invention has been described above with reference to the example embodiment, the present invention is not limited to the aforementioned example embodiment. Various changes understandable by those skilled in the art within the scope of the present invention can be made for the arrangements and details of the present invention.

This application claims priority based on Japanese patent application 2018-228704 filed on Dec. 6, 2018, and disclosures of which are incorporated herein in their entirety.

### REFERENCE SIGNS LIST

10 System Deployment device
11 Meta information acquisition unit
11A Meta information extraction unit
11B Meta information selection unit
12 Rule Management unit
13 Comparison score calculation unit
14 Mapping unit
15 Variable embedding unit
17 Meta information storage unit
100, 101 System deployment device
110 Meta information extraction unit
120 Rule Management unit
130 Comparison score calculation unit
140 Mapping unit
150 Variable embedding unit
160 Meta information selection unit
170 Meta information storage unit
200 Template
300 Design information
400 Specific deployment definition
500 Configuration information
600 IT system (verification environment)
700 IT system (operational environment)

What is claimed is:

1. A system deployment device generating a definition for specific system deployment, based on design information in which specific values of system configuration information used for IT system deployment are described, comprising:
a memory storing a software component; and
at least one processor configured to execute the software component to perform:
acquiring meta information relative to meaning with respect to setting of a variable part in a template describing the system configuration information,
comparing the variable part in the template with setting items in the design information, based on the acquired meta information and the design information, to score matching degree,
calculating optimal matching between the variable part in the template and the setting items in the design information, based on the scored matching degree, and
generating the definition for IT system deployment by assigning values corresponding to the setting items in the design information to the variable part in the template, based on the optimal matching.

2. The system deployment device according to claim 1, wherein
the at least one processor configured to execute the software component performs
managing extraction rules for extracting the meta information, and
extracting the meta information from the input template, referring to the extraction rules.

3. The system deployment device according to claim 2, wherein
the at least one processor configured to execute the software component performs deciding what type of information to extract the meta information as, depending on the use form, in the template, of the variable part in the template.

4. The system deployment device according to claim 3, wherein
rules that can specify what type of information the meta information is extracted as, depending on the use form, in the template, of the variable part in the template, are stored.

5. The system deployment device according to claim 1, further comprising meta information storage means for storing a plurality of meta information extracted from a group of templates describing the system configuration information used in the IT system deployment,
wherein the at least one processor configured to execute the software component performs selecting the meta information from the plurality of meta information stored in the meta information storage means, using information relative to an object to be deployed described in the configuration information.

6. The system deployment device according to claim 1, wherein
the at least one processor configured to execute the software component performs
the comparison score calculating means identifying comparison targets according to a type of the meta information acquired by the meta information acquiring means and structural positioning of the setting items in the design information,
scoring the matching degree between the comparison targets for the each comparison target,
calculating overall matching degree by averaging the scored matching degrees, and
calculating the optimal matching using the overall matching degree.

7. A computer-implemented system deployment method generating a definition for specific system deployment, based on design information in which specific values of system configuration information used for IT system deployment are described, comprising:
acquiring meta information relative to meaning with respect to setting of a variable part in a template describing the system configuration information,
comparing the variable part in the template with setting items in the design information, based on the acquired meta information and the design information, to score matching degree,
calculating optimal matching between the variable part in the template and the setting items in the design information, based on the scored matching degree, and
generating the definition for IT system deployment by assigning values corresponding to the setting items in the design information to the variable part in the template, based on the optimal matching.

8. The computer-implemented system deployment method according to claim 7, further comprising:
managing extraction rules for extracting the meta information, and
extracting the meta information from the input template in order to acquire the meta information, referring to the extraction rules.

9. The computer-implemented system deployment method according to claim 8, further comprising:
when extracting the meta information, deciding what type of information to extract the meta information as, depending on the use form, in the template, of the variable part in the template.

10. The computer-implemented system deployment method according to claim 9, further comprising:
managing rules that can specify what type of information the meta information is extracted as, depending on the use form, in the template, of the variable part in the template.

11. The computer-implemented system deployment method according to claim 7, further comprising:
selecting the meta information from a plurality of meta information stored in meta information storage means which stores the plurality of meta information extracted from a group of templates describing the system configuration information used in the IT system deployment, using information relative to an object to be deployed described in the configuration information.

12. The computer-implemented system deployment method according to claim 7, further comprising:
identifying comparison targets according to a type of the meta information and structural positioning of the setting items in the design information,
scoring the matching degree between the comparison targets for the each comparison target,
calculating overall matching degree by averaging the scored matching degrees, and
calculating the optimal matching using the overall matching degree.

13. A non-transitory computer readable recording medium storing a program, for implementing a system deployment method generating a definition for specific system deployment, based on design information in which specific values of system configuration information used for IT system deployment are described, when executed by a processor, performs,
acquiring meta information relative to meaning with respect to setting of a variable part in a template describing the system configuration information,
comparing the variable part in the template with setting items in the design information, based on the acquired meta information and the design information, to score matching degree,
calculating optimal matching between the variable part in the template and the setting items in the design information, based on the scored matching degree, and
generating the definition for IT system deployment by assigning values corresponding to the setting items in the design information to the variable part in the template, based on the optimal matching.

14. The non-transitory recording medium according to claim 13, wherein the program, when executed by the processor, performs,
managing extraction rules for extracting the meta information, and
extracting the meta information from the input template in order to acquire the meta information, referring to the extraction rules.

15. The non-transitory recording medium according to claim 14, wherein the program, when executed by the processor, performs,
when extracting the meta information, deciding what type of information to extract the meta information as, depending on the use form, in the template, of the variable part in the template.

16. The non-transitory recording medium according to claim 15, wherein the program, when executed by the processor, performs,
managing rules that can specify what type of information the meta information is extracted as, depending on the use form, in the template, of the variable part in the template.

17. The non-transitory recording medium according to claim 13, wherein the program, when executed by the processor, performs,
selecting the meta information from a plurality of meta information stored in meta information storage means which stores the plurality of meta information extracted from a group of templates describing the system configuration information used in the IT system deployment, using information relative to an object to be deployed described in the configuration information.

18. The non-transitory recording medium according to claim 13, wherein the program, when executed by the processor, performs,
identifying comparison targets according to a type of the meta information and structural positioning of the setting items in the design information,
scoring the matching degree between the comparison targets for the each comparison target,
calculating overall matching degree by averaging the scored matching degrees, and
calculating the optimal matching using the overall matching degree.
